(19) United States
(12) Patent Application Publication
(10) Pub. No.: US 2026/0064401 A1
(43) Pub. Date: Mar. 5, 2026

(54) AI TOOLS IN A PRIVATE CLOUD ENVIRONMENT

(71) Applicant: Hewlett Packard Enterprise Development LP, Spring, TX (US)

(72) Inventors: Michael J. Spitzer, Portland, OR (US); Frederick Gagne, Quebec (CA); Umesh Balikai, Bangalore (IN)

(21) Appl. No.: 18/952,914

(22) Filed: Nov. 19, 2024

(30) Foreign Application Priority Data
Sep. 5, 2024 (IN) 202441067370

(51) Int. Cl. G06F 8/65

(52) U.S. Cl. CPC G06F 8/65

(57) ABSTRACT

Efficient implementation of setup of racks with artificial intelligence (AI) tools in private or on-premises clouds and updating the AI tools are provided herein. Specifically, a remote cloud management system includes a private cloud AI platform orchestrator that is remote from a private cloud system. The remote cloud management system is configured to interface with the private cloud system using a connector and to orchestrate artificial intelligence (“AI”) operations on the private cloud system using the private cloud AI platform orchestrator. The remote cloud management system is also configured to manage AI software installed in the private cloud system.

### BACKGROUND

Artificial intelligence (“AI”) is a methodology for using a non-human system to learn from experience and imitate human intelligent behavior through machine learning. Thus, AI provides powerful tools that may be used to efficiently process and/or analyze large amounts of data. AI tools may be deployed to a suitable computing engine/hardware, such as being deployed in a cloud computing system.

Cloud computing systems may be implemented in numerous different ways include public clouds or private clouds. Public clouds may be deployed where users of the (often subscribing) public may have access to cloud services, while private clouds are restricted to one or more organizations. Indeed, the simplest private cloud may be administered by the single organization for use internally without providing services to others. One type of private cloud includes on-premises (on-prem) clouds where the administering entity controls or manages all hardware and software implemented in the private cloud at their own site.

### DRAWINGS

Features, aspects, and advantages of the present disclosure will become better understood when the following detailed description is read with reference to the accompanying drawings in which like characters represent like parts throughout the drawings, wherein:

FIG. 1 is a diagram illustrating a private cloud (on-prem) system with pre-configured AI tools and that is managed using a remote cloud management system, in accordance with aspects of the present disclosure;

FIG. 2 is a flowchart illustrating a process for accessing, updating, and/or deploying AI tools in the private cloud system of FIG. 1, in accordance with aspects of the present disclosure;

FIG. 3 is an example screen of an interface that may be used in the process of FIG. 2, in accordance with aspects of the present disclosure;

FIG. 4 is a diagram illustrating a process for adding new rack(s) to the private cloud system of FIG. 1, in accordance with aspects of the present disclosure;

FIG. 5 is an example screen that may be presented in a user interface as part of the process of FIG. 4, in accordance with aspects of the present disclosure;

FIG. 6 is an example network setup screen that may be presented in the user interface as part of the process of FIG. 4, in accordance with aspects of the present disclosure;

FIG. 7 is an example virtualization setup screen that may be presented in the user interface as part of the process of FIG. 4, in accordance with aspects of the present disclosure;

FIG. 8 is an example control plane setup screen that may be presented in the user interface as part of the process of FIG. 4, in accordance with aspects of the present disclosure;

FIG. 9 is an example worker node setup screen that may be presented in the user interface as part of the process of FIG. 4, in accordance with aspects of the present disclosure;

FIG. 10 is an example setup summary screen that may be presented in the user interface as part of the process of FIG. 4, in accordance with aspects of the present disclosure;

FIG. 11 is an AI stack that may be included in the private cloud system of FIG. 1, in accordance with aspects of the present disclosure;

FIG. 12 is an example status screen that may be presented in the user interface as showing one or more components of the private cloud system of FIG. 1, in accordance with aspects of the present disclosure;

FIG. 13 is an example software details screen that may be presented in the user interface in response to selecting a component of the status screen of FIG. 12, in accordance with aspects of the present disclosure;

FIG. 14 is a precheck screen that may be presented in the user interface to perform a software precheck on one or more components of the private cloud system of FIG. 1, in accordance with aspects of the present disclosure;

FIG. 15 is a download screen that may be presented in the user interface to download software updates for one or more components of the private cloud system of FIG. 1, in accordance with aspects of the present disclosure;

FIG. 16 is a flowchart illustrating a precheck process for the private cloud system of FIG. 1, in accordance with aspects of the present disclosure;

FIG. 17 is a flowchart illustrating a download updates process for the private cloud system of FIG. 1, in accordance with aspects of the present disclosure;

FIG. 18 is a flowchart illustrating a unified process for the private cloud system, in accordance with aspects of the present disclosure; and

FIG. 19 is a flowchart illustrating an update process for the private cloud system, in accordance with aspects of the present disclosure.

### DETAILED DESCRIPTION

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Embodiments provided herein relate to techniques for implementing setup and updating of racks of servers to implement artificial intelligence (“AI”) functionality in private clouds or on-premises (on-prem) private clouds managed using remote cloud management. As AI software and AI-oriented hardware become more widely available from numerous sources, the options for implementing AI solutions become near limitless. Since the administrative entity is responsible for all hardware and software including AI tools, it may become complicated to even choose which hardware and software to implement in the on-prem cloud. Managing the hardware and software can be even more difficult due to resources arriving from multiple disparate sources. Furthermore, being responsible for all management of an on-prem private cloud may make it difficult to keep such software and/or hardware up-to-date especially with updates arriving from multiple disparate sources. The current techniques simplify the process for customers to incorporate new hardware with AI functionality in the on-prem private clouds by streamlining the setup process by shipping a rack of server(s) with the AI already setup on the rack. For instance, a customer may select a configuration and/or use case that includes hardware and software suitable for AI uses that the customer desires. The integrated hardware and software may be set to a standard using infrastructure as a service (IaaS) to use subscription modeling to acquire infrastructure using periodic payments and/or using other suitable computing model recommendations and/or sizing to meet model/use case/or token(s) needs. Once the standardized option is selected and purchased, the cloud manager/manufacturer may have the rack(s) delivered to the customer site within a specified period of time (e.g., 8 hours).

When the rack(s) are delivered to the customer site, the customer and/or manager/manufacturer may physically install the rack(s) and power on the rack(s). As previously noted, the rack(s) may be pre-configured with AI tools, such as vendor-specific and/or open-source tools, models, and/or other AI support. Since the AI tools are already pre-configured into the rack(s), the setup is simply dependent upon implementing the connection between the rack(s) and the remote cloud management. Thus, the setup may be simplified into an online setup of 1) configuring network access for the rack(s), 2) configuring user access of users that use the rack(s)/on-prem private cloud, and 3) establishing the link to the remote cloud for management of the on-prem private cloud. This setup may include default values (e.g., location) that may be changed during setup and/or after arrival. In some embodiments, if the new rack(s) are added to rack(s) already managed by the remote cloud, the new rack(s) may be added via the remote cloud and linked to remote cloud accordingly. The remote cloud may enable migrating workloads and/or expanding capacity to meet changing consumer AI demands.

After installation and/or as part of the installation of the rack(s), the rack(s) may have software updates that are to be applied to the rack(s). Using the remote cloud management, the update may also be simplified. For instance, the AI tools may be updated using a simple (e.g., single-click) update using the remote cloud. The update may begin with initiation through a user interface that interacts with and/or is part of the remote cloud management system. The update may occur as a single operation that includes a download of updates and application of the update or may be separate operations with the download occurring at a separate time from the application of the updates. Before downloading and/or applying the updates, the remote cloud management system may check which updates are available in a cloud repository for the AI tools and suitable for the components of the on-prem private cloud. The remote cloud management system may also check to make sure that the system is in a non-degraded state with no failed components. The updates may follow a specific order with a data service connector update that is applied to update a data service connector between the on-prem private cloud and the remote cloud management system. The updated data service connector is then used for subsequent parts of the update, such as updating a control plane, updating BIOS/firmware/OS, virtualization components (e.g., virtual machines (VMs) and their components), and/or other parts of the on-prem private cloud.

These installation and update techniques may provide an overall improvement for consumers that use on-prem private clouds to simplify installation of a pre-configured rack for a first type of AI workload and a different pre-configured rack for a second type of AI workload. The remote cloud management may also install updates for the whole AI stack including the control plane, firmware, storage, OS, AI software/nodes, and the like using a simplified update process with a specified ordering of application of updates.

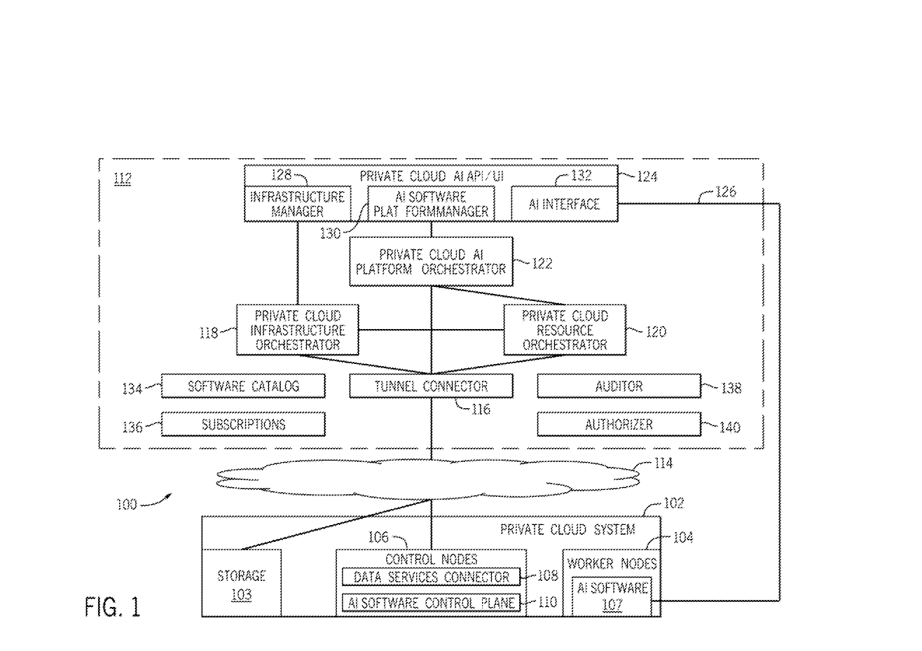

With the foregoing in mind, FIG. 1 is a diagram illustrating a system 100 that implements cloud-based AI tools. The system 100 includes a private cloud system 102 that is at least partially administered by a customer organization. The private cloud system 102 may be an on-prem cloud system where hardware related to the cloud services implemented using the private cloud system 102 are at least partially located on-site and are located in at least one of the customer organization’s physical sites. Such on-prem cloud solutions may be desired by customers in situations where they desire to keep at least some of the hardware and/or its data on-site. This freedom to manage its own hardware may also provide the customer with the ability to create a bespoke configuration with specifically selected hardware and/or software solutions. However, using such bespoke configurations may also complicate deploying new hardware, new software, managing current software or hardware, and/or updating current software to newer versions due to the custom nature of solutions from multiple manufacturers and/or providers with different sources for obtaining configurations and/or settings.

The private cloud system 102 may use a container orchestration system that acts as an operating system for the private cloud system 102. The container orchestration system may assemble one or more computers including virtual machines (VMs) and/or bare metal servers (BMs) into clusters that perform workloads in containers. For instance, the container orchestration system may include Kubernetes®, an open-source container orchestration system, and/or any other suitable container orchestration systems. The container orchestration system may function with one or more container runtimes, such as HPE Ezmeral®, Docker®, Podman®, Kubernetes Container Runtime Interface (CRI-O), Containerd®, rkt, and/or any other suitable container runtimes to perform the workloads in the containers.

Since the private cloud system 102 is implemented using computers using one or more servers (e.g., BMs) along with one or more VMs, the private cloud system 102 includes a combination of hardware elements (e.g., processors) and software elements including tangible, non-transitory, and computer-readable medium, such as in storage 103. The storage 103 may include any suitable articles of manufacture for storing data and/or executable instructions, such as random-access memory, read-only memory, rewritable flash memory, hard drives, and optical discs. In addition, programs (e.g., using container runtimes and/or the container orchestration system) encoded on such a computer program product may also include instructions that may be executed by processor(s) of the private cloud system 102 to enable the containers of the private cloud system 102 to perform workloads in the containers.

As illustrated, the private cloud system 102 includes worker nodes 104 and control nodes 106. The worker nodes 104 run applications, such as AI software 107, in the cluster. The worker nodes 104 process data and handle networking for the private cloud system 102. The worker nodes 104 host application containers in groups that, in turn, run one or more containers. The worker nodes 104 report to the control nodes 106. The control nodes 106 manage the operations of the private cloud system 102 by controlling when and which of the worker nodes 104 run the containers. In other words, the control nodes 106 include a scheduler that communicates with the worker nodes 104 to schedule container workloads. The scheduler may consider computing availability, such as CPU and memory availability, along with application (e.g., AI software 107) needs in deciding which worker nodes 104 are to perform which tasks at which times. The worker nodes 104 may utilize node-level agents that track resource consumption and facilitate completing schedule assignments of worker nodes 104 and assuring that the worker nodes 104 perform assigned tasks.

The control nodes 106 manage communication and control of the worker nodes 104 and may include an application programming interface (API) server along with storing configuration and state data. In some embodiments, a control plane (e.g., AI software control plane 110) may run across multiple the control nodes 106 to provide redundancy.

The control nodes 106 may also communicate with outside services by implementing a data services connector 108. The control nodes 106 may also include the AI software control plane 110 that is used to control (e.g., schedule) workloads in application containers of the AI software 107. As discussed below in more detail, the AI software 107 may include software made available by one or more different providers, such as Hewlett Packard Enterprise Company HPE, NVIDIA, open-source partners, and/or other tools that may be provided to the private cloud system 102 via a remote cloud management system 112.

The system 100 includes the remote cloud management system 112 that is used to manage the private cloud system 102 via one or more networks 114 (e.g., the Internet) and the data services connector 108 implemented in the control nodes 106 of the private cloud system 102. The remote cloud management system 112 is remote from the private cloud system 102, but the remote cloud management system 112 may be used to perform remote management for the private cloud system 102 via a tunnel connector 116. The remote cloud management system 112 is remote from the private cloud system 102 in that the remote cloud management system 112 may be implemented using different computer/servers at different site(s) than those used to implement the private cloud system 102. The tunnel connector 116 pairs with the data services connector 108 to create a secured (“encrypted”) remote connection through the one or more networks 114 to keep information secure and confidential between the remote cloud management system 112 and the private cloud system 102.

The remote cloud management system 112 uses a combination of hardware and software to implement a private cloud infrastructure orchestrator 118, a private cloud resource orchestrator 120, a private cloud AI platform orchestrator 122, and a private cloud AI API/user interface (UI) 124.

The private cloud infrastructure orchestrator 118 orchestrates operations related to setting up infrastructure of the private cloud system 102 (e.g., setting up the control nodes 106, connecting the private cloud system 102 to the remote cloud management system 112, etc.). The private cloud infrastructure orchestrator 118 also controls software updates, inventories for the private cloud system 102, controls network management for the private cloud system 102, monitors/controls metering of resources (e.g., processing, RAM, and/or power) used by the infrastructure during operations using the private cloud system 102, and/or generating dashboards for showing information about the infrastructure of the private cloud system 102.

The private cloud resource orchestrator 120 orchestrates operations using components, such as VMs, BMs, and/or the container orchestration system of the private cloud system 102. For instance, the private cloud resource orchestrator 120 may be used to provision and manage the VMs, the BMs, and/or the container orchestration system (e.g., Kubernetes) of the private cloud system 102.

The private cloud AI platform orchestrator 122 may be used to manage the AI platform using the AI software 107. For instance, the private cloud AI platform orchestrator 122 may deploy and/or expand AI applications installed and available in the AI software 107 of the private cloud system 102. The private cloud AI platform orchestrator 122 may perform such deployment and/or expansion of the inventory of the AI software 107 using the tunnel between the tunnel connector 116 and the data services connector 108 and/or via a sideband connection 126 between private cloud AI API/UI 124 and the AI software 107. For instance, the sideband connection 126 may be a secured tunnel that is separate from the tunnel between the data services connector 108 and the tunnel connector 116.

The private cloud AI API/UI 124 may provide a UI to enable remote management of the AI software 107 in the private cloud system 102 using APIs. For instance, a user may log into the remote cloud management system 112 and use APIs, such as representational state transfer (REST) APIs, to control changes in the private cloud system 102 via the private cloud infrastructure orchestrator 118 and/or the private cloud resource orchestrator 120. The private cloud AI API/UI 124 includes an infrastructure manager 128 that manages infrastructure changes using API calls through the private cloud infrastructure orchestrator 118 to make changes to management of the infrastructure and/or changes to the infrastructure itself. The private cloud AI API/UI 124 also includes an AI software platform manager 130 that manages changes to the AI software 107 and/or the AI software control plane 110 via the private cloud resource orchestrator 120 and/or the private cloud AI platform orchestrator 122. Additionally or alternatively, the private cloud AI API/UI 124 may make changes to the AI software 107 using the sideband connection 126 through an AI interface 132 that may be used to authenticate and/or encrypt the sideband connection 126 between the private cloud AI API/UI 124 and the private cloud system 102.

The remote cloud management system 112 may include additional components to aid in the remote management of the private cloud system 102. For instance, the remote cloud management system 112 may include a software catalog 134 that stores and/or links to available software that is available for use in the private cloud system 102. For instance, the software catalog 134 may determine what software is appropriate and available for a specific configuration of the hardware and/or software of the private cloud system 102. For instance, if the organization/user associated with the private cloud system 102 is subscribed to AI services (e.g., from a provider of the remote cloud management system 112 and/or from third-party providers), the software catalog 134 may provide corresponding AI tools as available for installation/use in the private cloud system 102. In addition to or in alternative to subscription-based filtering, the software catalog 134 may be filtered according to whether the organization/user associated with the private cloud system 102 has fulfilled requirements before providing at least some AI services. For instance, the software catalog 134 may refrain from displaying AI tools from at least some providers (e.g., third-party providers) until the organization/user has indicated that they agree to an agreement with the respective providers. For instance, the agreement may be an end-user license agreement (EULA) and/or other licensing agreements.

The remote cloud management system 112 may include an auditor 138 that may be implemented using hardware and/or software to enable a user/organization to view metrics related to ongoing and/or historical workloads of the private cloud system 102. The remote cloud management system 112 may include an authorizer 140 that completes authorization for any user that attempts to access the remote cloud management system 112 and/or the private cloud system 102 before providing such access.

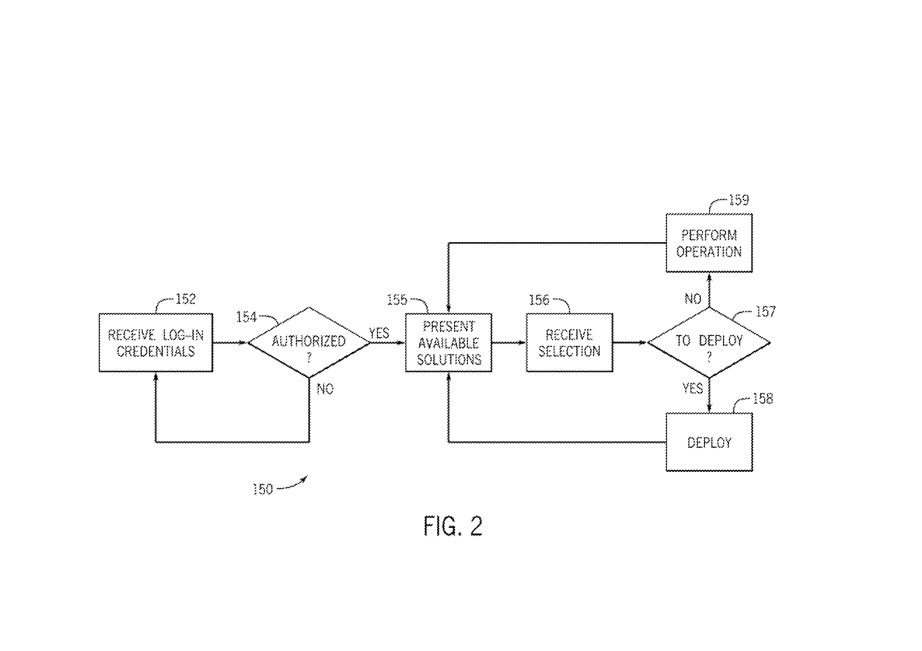

In operation, a user may select which AI tools may be used in the private cloud system 102. FIG. 2 shows a process 150 for deploying AI tools in the private cloud system 102 using the remote cloud management system 112. The remote cloud management system 112 receives log-in credentials for a user via the private cloud AI API/UI 124 (block 152). The remote cloud management system 112 uses the authorizer 140 to check whether the user is authorized to deploy, change, and/or use the AI software 107 in the private cloud system 102 (block 154). If the credentials are invalid or the user is not authorized to access, use, and/or change the AI software 107, the credentials are not authorized, and the remote cloud management system 112 may re-request log-in credentials. In some embodiments, the remote cloud management system 112 may only receive attempted credentials a limited number of times (e.g., 1, 2, 3, 4, or more times) before locking the account, logging the failed authorization check, and/or notifying an administrator of the failed authorization check for the credentials.

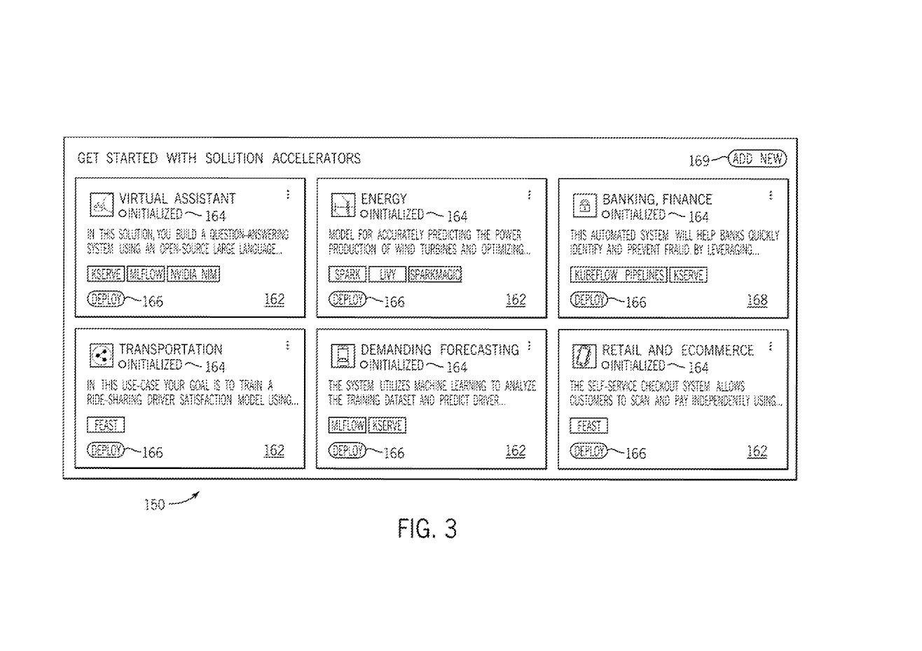

If the authorization is successful, the remote cloud management system 112 presents available solutions in the private cloud AI API/UI 124 (block 155). For instance, FIG. 3 shows a screen 160 that may be presented in the private cloud AI API/UI 124 that shows deployable AI tools 162 that are pre-configured in rack(s) of the private cloud system 102 as indicated by an initialized tag for respective statuses 164. These deployable AI tools 162 may be deployed via the remote cloud management system 112 using a deploy button 166.

For already deployed AI tools 168 as indicated by a deployed tag for its status 164, no deploy button 166 is shown, and the deployed AI tools 168 may be opened, edited, or run by clicking on the already deployed AI tools 168. In some embodiments, using an add button 169, AI tools (e.g., AI solution accelerators) that are not initialized or deployed may be added from the software catalog 134 based on suitability to the private cloud system 102 and/or based on subscriptions 136 available for the credentials used to log into the remote cloud management system 112.

In some embodiments, the deployable AI tools 162 and the deployed AI tools 168 may include a description and/or tags that indicate the objectives, field of use, platforms, programming languages, and/or other details about the respective AI tools and/or how they may be used.

Returning to FIG. 2, one of the presented selections is received via the private cloud AI API/UI 124 (block 156). For instance, one of the deployable AI tools 162, one of the deployed AI tools 168, and/or the add button 169 may be the received selection selected via the screen 160 of the private cloud AI API/UI 124. If the selection corresponds to a new deployment (or addition of an AI tool via the add button 169) (block 157), the remote cloud management system 112 deploys a new AI tool (block 158). In some embodiments, deploying the new AI tool may include modifying the AI workloads in the worker nodes 104 to accommodate the newly deployed AI tool. Deploying may also include showing a status of the deployment before, during, and/or after the deployment is complete. For example, the screen 160 may be updated to show status information, such as deployed, deploying with a percentage complete indicator, and/or other suitable indicators of the status of deployment.

If the selected solution is already deployed, the remote cloud management system 112 may perform an operation (block 159). For instance, the operation may include adjusting the workload of the selected AI tool, running a process using the selected AI tool, stopping running of the selected AI tool, viewing data results of execution of the AI tool, running the AI tool against different input data, and/or any other suitable operations that may use the selected AI tool.

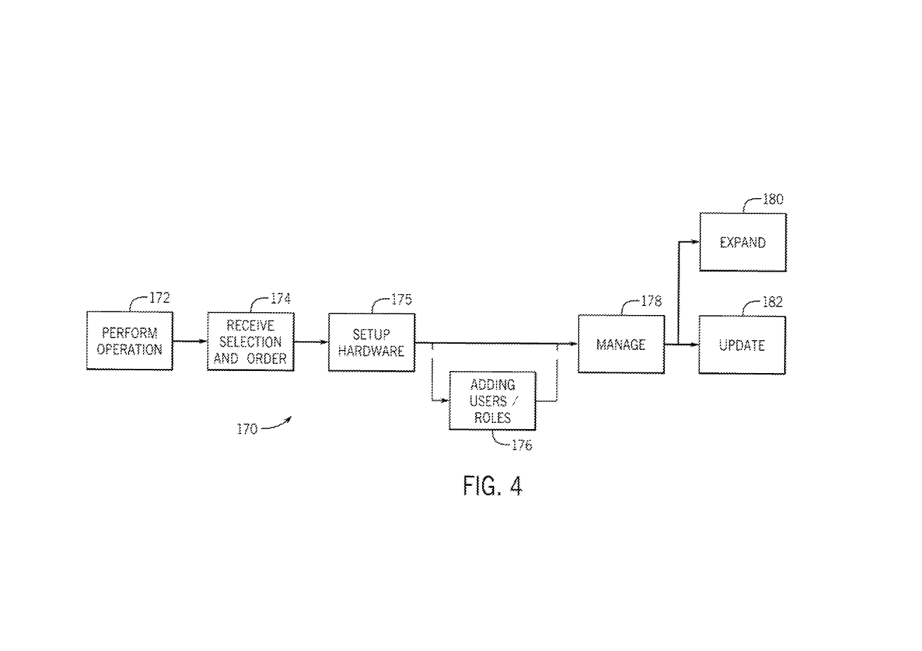

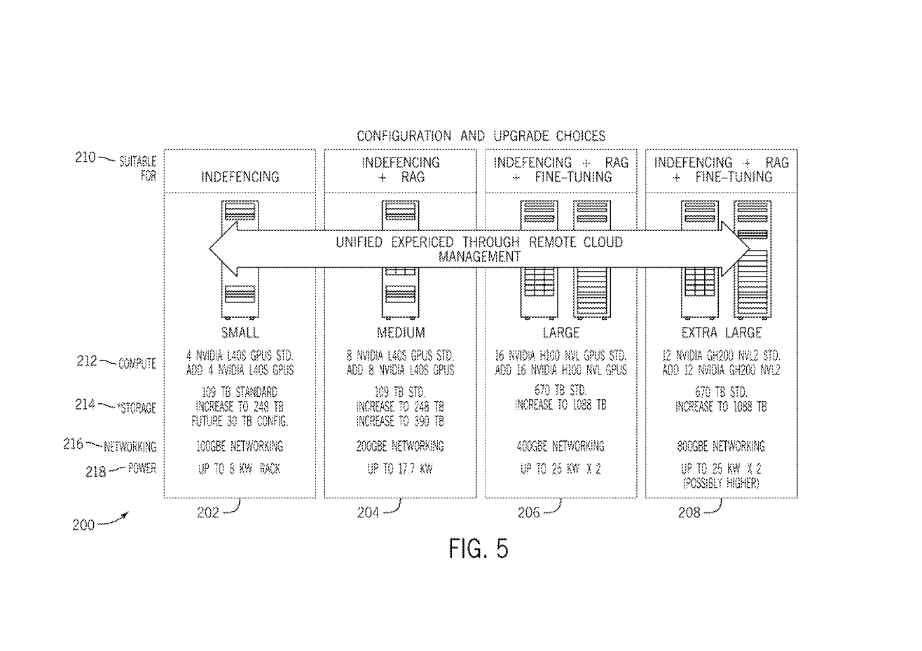

In some situations, adding or deploying new AI tools may consume a large portion of the private cloud system 102. In this case or an initial setup of the private cloud system 102, hardware is to be added to the private cloud system 102 to implement the AI tools. However, a user or AI administrator that completes the operation may be a different category of user (e.g., cloud administrator) that has the authority/capability to add new hardware to the private cloud system 102. FIG. 4 shows a process 170 for acquiring and provisioning hardware in the private cloud system 102 with pre-configured AI tools. The remote cloud management system 112 via the private cloud AI API/UI 124 may present options for hardware to be implemented (block 172). The presentation of the options may be made in response to authentication verification, such as discussed above in relation to FIG. 2. FIG. 5 shows a screen 200 that may be displayed in the private cloud AI API/UI 124. The screen 200 may be presented when an authorized user requests to see options for creating and/or expanding the private cloud system 102 with new and/or replacement hardware. The screen 200 includes a set of different configurations 202, 204, 206, and 208 that may be added to the private cloud system 102. In some embodiments, the configurations 202, 204, 206, and 208 may be generic options suitable for implementing AI operations. Additionally or alternatively, the configurations 202, 204, 206, and/or 208 may be recommendations based on hardware already in the private cloud system and/or based on information provided by the cloud administrator or the cloud administrator’s organization. For instance, recommended configurations may prioritize using configurations similar to what rack(s) are already deployed in the private cloud system 102. Additionally or alternatively, the recommended configurations may be based on indications of which types of AI operations are anticipated, compute demands expected for the anticipated AI operations, storage demands expected for the anticipated AI operations, networking demands expected for the anticipated AI operations, and/or a power budget for the new additions.

Each of the configurations 202, 204, 206, 206, and 208 may have corresponding AI functions, such as inferencing, retrieval-augmented generation (RAG), model fine-tuning, other AI functions, or a combination thereof. RAG is an AI framework that uses traditional information retrieval systems such as databases in the storage 103. RAG optimizes large language models (LLMs) by enabling them to access and incorporate up-to-date information from the curated databases into their responses and analysis. This additional knowledge may enable a more accurate, relevant, and up-to-date analysis and/or suggestions based on preferences. Model fine-tuning uses more training examples than few-shot learning by taking a model (e.g., a few-shot learning-based model) and performing iterative supervised or unsupervised levels of training on the model to fine tune the model. The configurations 202, 204, 206, and/or 208 may be tagged with a suitability tag 210 indicating the operations to which the respective configurations are more well suited. Additionally or alternatively, the cloud administrator may select the anticipated AI functions in the private cloud AI API/UI 124 at the time of reviewing the options or may be pre-configured and stored in preferences for the remote cloud management system 112. Alternatively, the cloud administrator may indicate which configuration (e.g., small, medium, large, or extra-large) is desired.

The screen 200 may also provide information about the different configurations 202, 204, 206, and/or 208. For instance, the screen 200 may display compute components indications 212 for the configurations 202, 204, 206, and/or 208. For instance, the compute components may include graphics processing units (GPUs), central processing units (CPUs), application-specific integrated circuits (ASICs), programmable logic devices (PLDs), field-programmable gate arrays (FPGAs), other processors suitable for use in AI computations, or a combination thereof.

The screen 200 may further display storage components indications 214 for the configurations 202, 204, 206, and/or 208. The storage components indication 214 may include an amount of memory and/or storage. In some configurations, the type of memory (e.g., latency and/or frequency) may be selectable via the storage components indication 214 or through another interface. The storage components indications 214 may indicate a base amount of storage and/or one or more upgraded amounts of storage that may be selected for deployment in the rack(s) when installed in the private cloud system 102. Additionally or alternatively, the storage components indications 214 may indicate a maximum amount of storage that may be added to the configuration at a later time.

The screen 200 may further display networking indications 216 for the configurations 202, 204, 206, and/or 208. The networking indications 216 may indicate data transfer speeds for the respective configurations. The screen 200 may also include a power indicator 218 that indicates a power consumption estimate for the respective configurations.

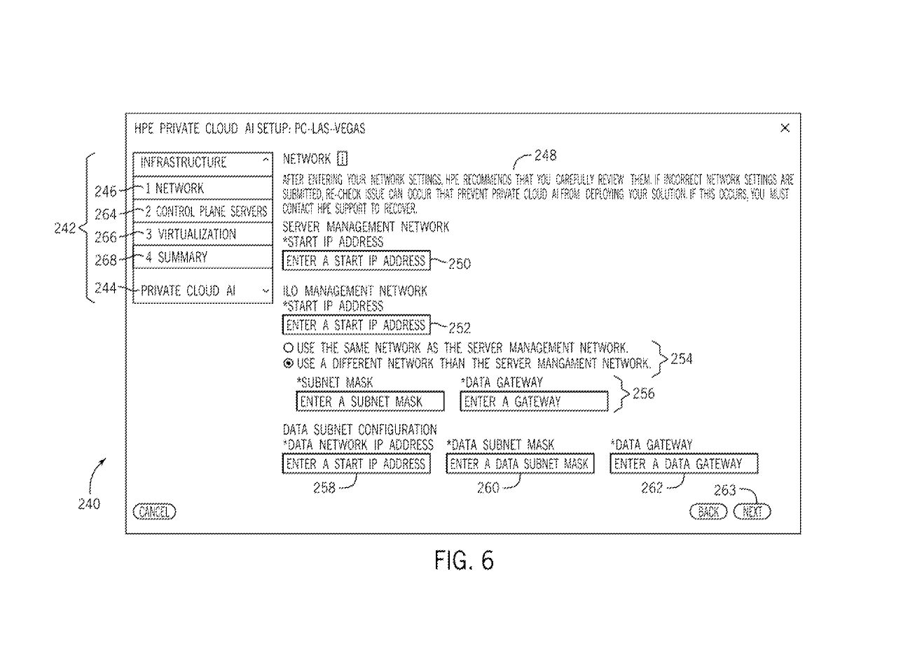

Returning to FIG. 4, the private cloud AI API/UI 124 may receive a selection of one of the presented options and orders the respective configuration (block 174). In some embodiments, the selection and order may be performed offline (e.g., over the telephone and/or using order hardcopy or softcopy forms) with an agent of the provider of the remote cloud management system 112 completing the selection and ordering. The provider then provides the ordered rack(s) with pre-loaded AI tools and/or access to AI tools. The provider and/or the ordering organization then sets up the hardware (block 175). FIGS. 6-9 discussed below relate to this hardware setup.

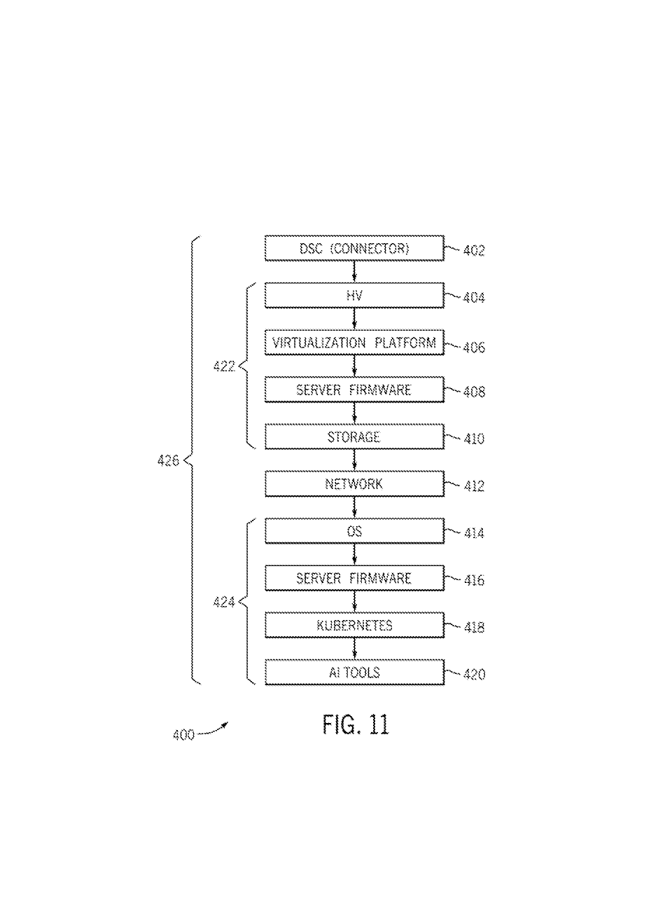

Before, during, and/or after ordering the hardware, the cloud administrator adds users and/or roles of users for the rack(s) (block 176). For instance, the cloud administrator may add the log-in credentials used in FIG. 2 that are used to setup, change, and/or use the AI software 107 in the private cloud system 102 via the newly setup hardware. As such, some users may be permitted to change the AI tools (e.g., start fine-tuning) while other users may merely be granted permission to access or view results of AI operations. The cloud administrator may then use the private cloud AI API/UI 124 to manage the private cloud system 102 including observing workloads and/or other AI dashboards available in the private cloud AI API/UI 124. From this point, the cloud administrator may expand the order/private cloud system 102 to include additionally available hardware and/or software components (block 180). For instance, the private cloud AI API/UI 124 may return to presenting options in block 172. From the management/observation step, the cloud administrator may use the private cloud AI API/UI 124 to update the AI stack in the rack(s) in the private cloud system 102 (block 182). FIGS. 11-14, discussed below, relate to this update mechanism.

### Hardware Setup

As previously noted, FIG. 6 relates to hardware setup of rack(s) in the private cloud system 102 using the private cloud AI API/UI 124 and/or any other portion of the remote cloud management system 112 and/or the private cloud system 102. As such, FIG. 6 shows a screen 240 that the private cloud AI API/UI 124 and/or other parts of the remote cloud management system 112 may present to the cloud administrator as part of the setup. The screen 240 includes a progress tracker that includes an infrastructure portion 242 and a private cloud AI portion 244. As illustrated in the progress tracker, the infrastructure is setup before the private cloud AI (e.g., AI software 107 of the private cloud system 102) is setup, the infrastructure portion 242 is expanded while the private cloud AI portion 244 is collapsed. In the infrastructure portion 242, the progress tracker includes a network portion 246 that is used to configure the network as part of the setup. The network portion 246 is bolded and/or otherwise emphasized to indicate that the network is currently being set up. In the network setup, the screen 240 shows text 248 that may be used to give instructions on completing the network configuration portion of the setup. The screen 240 also includes a server management network input 250 that enables entry of an IP address of the remote cloud management system 112 to enable establishing the connection between the remote cloud management system 112 and the private cloud system 102.

The screen 240 further includes an integrated lights-out (iLO) management network input 252 that enables entry of an IP address of an iLO management system used to manage, simplify, and/or automate server operations remotely and securely. The iLO management network input 252 may be at the same address as the remote cloud management system 112 indicated in the server management network input 250. Accordingly, the screen 240 includes a selector 254 that enables the cloud administrator to indicate that both the remote cloud management system 112 and the iLO management system share the same IP address. If the selector 254 indicates that the IP address is the same for both networks, the iLO management network input 252 and/or the server management network input 250 may be hidden or otherwise disabled. When using the same or different IP addresses for the iLO management network and the remote cloud management system 112, the screen 240 includes an iLO subnet input 256 that enables the cloud administrator to specify a specific subnet mask and gateway for the iLO management network. Since the private cloud system 102 also has data to be used in the AI operations in the storage 103 and/or other locations, the screen 240 enables entry of an IP address 258, data subnet mask 260, and/or a gateway 262 to access the data to be used in the AI operations in the private cloud system 102.

Once the network has been configured in the screen 240, a next button 263 may be selected to advance to a control plane servers portion 264 of the progress tracker. Like the management networks, locations (e.g., IP addresses, subnet masks, and/or gateways), serial numbers, models, CPU families, and/or other information about the control plane servers may be input into the private cloud AI API/UI 124. Once the location of the control plane servers is designated and/or a respective next button is selected, virtualization is also setup using a virtualization portion 266 of the progress tracker. Once the infrastructure setup has been completed, a summary portion 268 of the progress tracker may be selected (e.g., using a next button in the virtualization portion of the setup).

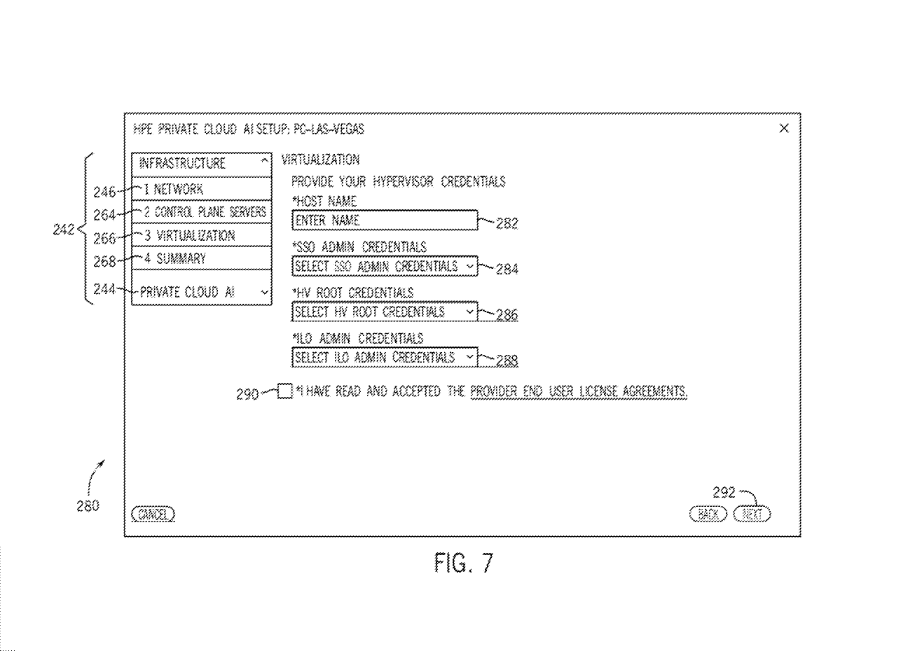

FIG. 7 is a diagram of a screen 280 that may correspond to the virtualization portion 266 of the progress tracker. As such, the screen 280 may be presented using the private cloud AI API/UI 124 and/or any other portion of the remote cloud management system 112 and/or the private cloud system 102. The screen 280 includes a host name input 282 that is configured to receive a host name for server management software for controlling virtual machine environments. For instance, the server management software may include any suitable server management software, such as NVIDIA virtual GPU (vGPU) software, VMware vCenter, and/or other suitable server management software packages. The screen 280 also includes a credentials input 284 used to input hypervisor (HV) credentials for the server management software, the remote cloud management system 112, and/or the private cloud system 102. For instance, the credentials may include single sign-on (SSO) credentials that are digital credentials that may be used for multiple applications or websites, such as the server management software and/or other locations in the remote cloud management system 112 and/or the private cloud system 102. The credentials input 284 may include a dropdown menu and/or popup menu that enables selection of the credentials.

The screen 280 also includes a hypervisor (HV) root credentials entry 286 that enables entry of HV root credentials using manual entry, a dropdown menu, a popup menu, or other mechanism for inputting the credentials to be used in authenticating to the hypervisor. The hypervisor is installed on the rack(s) and used to partition the rack(s) into VMs. Similarly, an iLO admin credentials entry 288 enables entry of iLO admin credentials to authenticate to the iLO management software previously discussed. The screen 280 may present an acceptance button 290 along with a statement to accept one or more agreements with providers of the various pieces of application software (e.g., AI software 107) and/or management tools. The statement may include a link to the various different agreements even among different providers. Once the virtualization credentials have been provided, a next button 292 may be selected to advance.

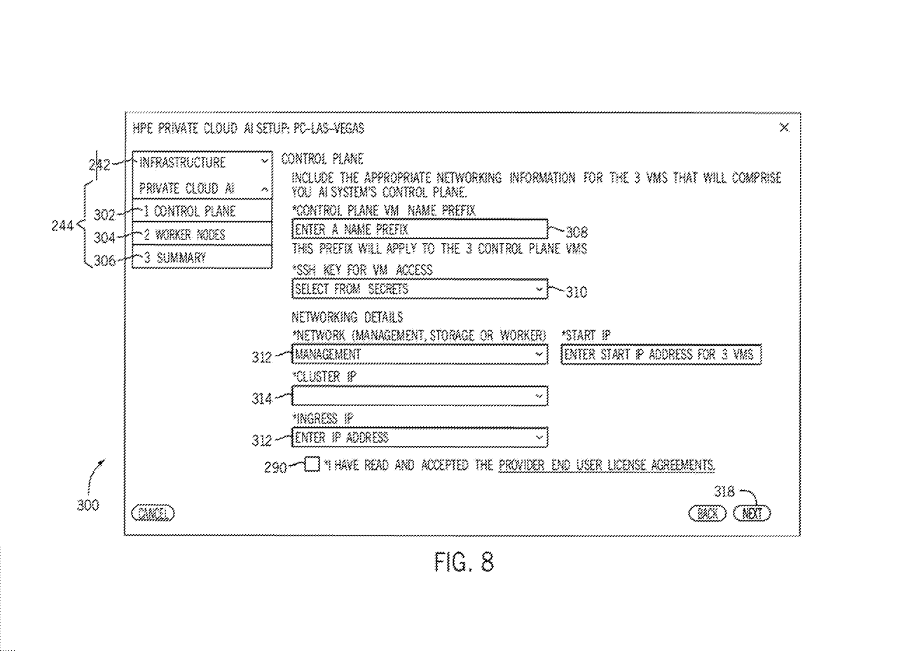

Once the infrastructure setup has been completed, the progress tracker may proceed to the private cloud AI portion 244 as illustrated in screen 300 of FIG. 8. In the screen 300, the private cloud AI portion 244 is expanded while the infrastructure portion 242 is collapsed indicating that the setup has moved to the private cloud AI portion 244 of the setup. As illustrated, the private cloud AI setup may be divided into a control plane setup, a worker nodes setup, and a summary as indicated by indications 302, 304, and 306. Since the control plane is currently being configured using the screen 300, the screen 300 includes the indication 302 being bold, italicized, underlined, and/or otherwise emphasized while the indications 304 and 306 are de-emphasized. The screen 300 includes a control plane VM name prefix input 308 used to input a name prefix for one or more (e.g., 3 for redundancy) control plane VMs. The screen 300 also includes a key input 310 for inputting a key used to access VMs and that may be selected from a list of stored secrets and/or uploaded to the private cloud AI API/UI 124.

The screen 300 further includes networking details for management, storage, or worker nodes by selecting a network from a network menu 312. The control plane VMs are then given a starting IP address using a start IP input 316 used to indicate a first IP address for a first VM. The next VMs are given the next available addresses. The networking details also enables indicating a cluster IP address using a cluster IP input 314 and indicating an ingress IP address using an ingress IP input 316. Once the information has been input, the next step of the AI setup related to worker nodes may be accessed when a next button 318 is enabled due to completion of inputting data.

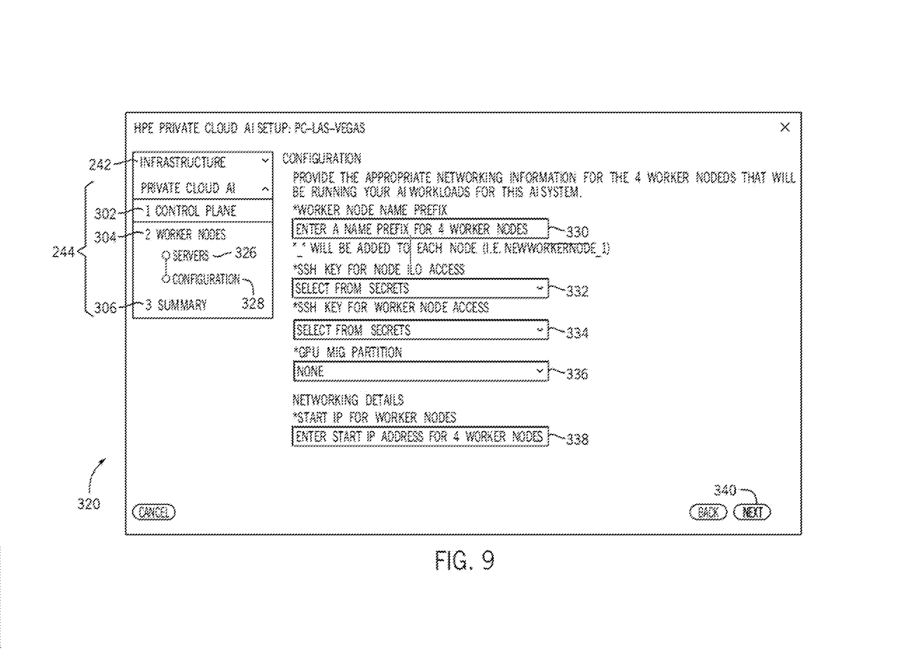

Once the next button 318 is pressed, the private cloud AI API/UI 124 causes the screen 320 to be displayed as illustrated in FIG. 9. The screen 320 includes emphasis of the indication 304 and expansion of the indication 304 to include indications 326 and 328. The indication 326 corresponds to servers for the worker nodes 104 and may be used to input an IP address, a name, a serial number, a type of appliance, a type of processor used, an amount of storage, and/or any other useful information about the servers that implement the worker nodes 104. The indication 328 may be used to configure the worker nodes 104. As indicated by the emphasis of the indication 328, the setup is ongoing for configuring the worker nodes 104. To aid in completing configuration of the worker nodes 104, the screen 320 includes a worker node name prefix input 330 to enable a human readable prefix to be affixed to each worker node 104. The screen 320 further includes key inputs 332 and 334 that enable respective keys to be input for respective access using iLO and using a worker node operating system, such as red hat enterprise Linux (RHEL). The configuration may include a participation input to enable specification of a partition of a multi-instance GPU (MIG) 336, if applicable. The screen 320 may also enable entry of a start IP 338 for the worker nodes 104 for some number (e.g., 4) of worker nodes 104 where each worker node 104 is assigned a next available number. Once configuration of the worker nodes 104 has been entered, the setup may continue by receipt of a selection of a next button 340.

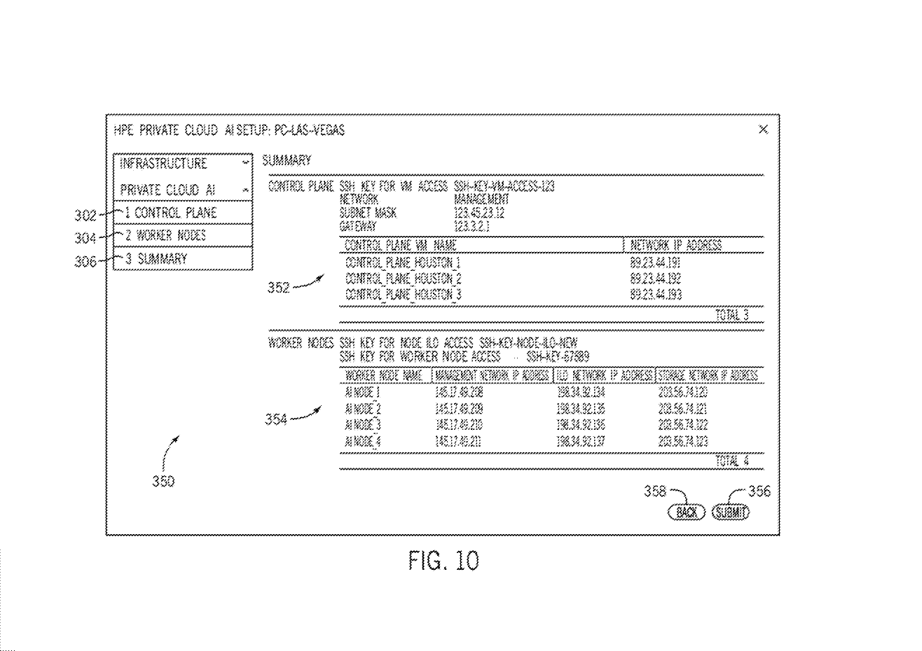

Upon completion of the configuration, as illustrated in FIG. 10, a screen 350 may be presented using the private cloud AI API/UI 124 presenting a summary of the setup of the private cloud AI portion 244 as indicated by the emphasis of the indication 306. The summary includes control plane details 352 about the control plane/control nodes 106. For instance, the summary may include the key for VM access, the network name, a subnet mask, a gateway for the control nodes, names for each control node 106 and their individual IP addresses, or any combination thereof. The summary also includes information 354 about worker nodes 104, such as a key for iLO access, a key for OS access, names for the worker nodes 104, IP addresses for the worker nodes 104 on the management network, IP addresses for the worker nodes 104 on the iLO network, and IP addresses for the worker nodes 104 in a network for the storage 103. In some embodiments, the summary may include a status indicator indicating a status of the configuration, such as 0, 5, 10, 25, or more percent complete. Once the summary details have been confirmed, a submit button 356 may be selected. Otherwise, a back button 358 on this screen 350 or on previous screens may be used to navigate back to change/update information about the control plane and/or worker nodes as part of the setup.

FIG. 11 shows an example AI stack 400 that includes a data services connector (DSC) 402, such as the DSC 108 of FIG. 1. The AI stack 400 also includes a hypervisor (HV) 404 (e.g., ESXi), a virtualization platform 406 (e.g., vSphere), server firmware 408 for control nodes 106, storage 410, network connectivity 412, an operating system 414 used for the worker nodes 104 used to implement the AI software 107, server firmware 416 for the worker nodes 104, Kubernetes 418 and/or other container orchestration systems, and other AI tools 420. For instance, the AI tools 420 may be tools made available from the provider of the remote cloud management system 112, another provider (e.g., 3^{rd} party provider, such as NVIDIA), open-source tools, and/or other AI tools that may be made available to the private cloud system 102 via the software catalog 134 of the remote cloud management system 112. The HV 404, the virtualization platform 406, the server firmware 408, and the storage 410 may be part of the control pane for the private cloud system 102, as noted by indication 422. The operating system 414, the server firmware 416, Kubernetes 418, and the AI tools 420 may be part of and/or implemented using the worker nodes 104, as noted by indication 424. As may be appreciated, the different sources of updates for the different objects in the AI stack 400 may make such updates more difficult and/or complicated. To simplify this process, the private cloud infrastructure orchestrator 118, the private cloud resource orchestrator 120, the private cloud AI platform orchestrator 122, and the private cloud AI API/UI 124 may be used to implement a simplified update with multiple (e.g., all) of the objects in the AI stack 400 being updated in a compound operation and/or using a single action (e.g., one click). In some embodiments, at least some components of the AI stack 400 may be updated using a separate operation. For instance, the DSC 402 may be updated using an VM image stored in the remote cloud management system 112 that may be updated by the customer directly using the remote cloud management system 112. Additionally or alternatively, the network connectivity 412 may be updated by the customer using a direct update.

### Software Update

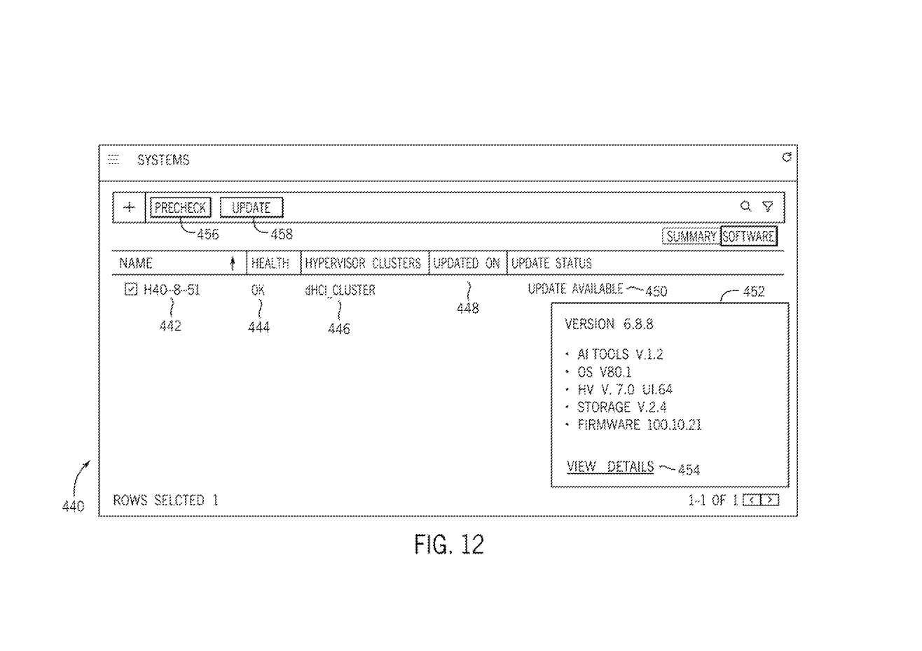

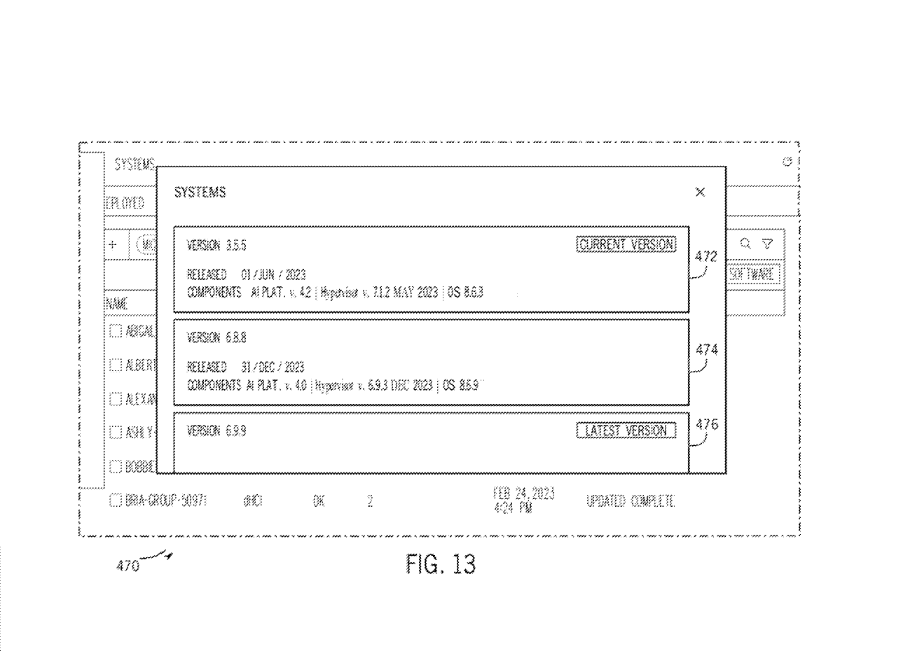

FIG. 12 shows a screen 440 that may be presented via the private cloud AI API/UI 124 and/or any other part of the remote cloud management system 112. The screen 440 shows a list of one or more records of software that may have an available update. In some embodiments, all deployed AI tools may have records shown, but in some embodiments, only records that have a potential update in any part of the AI stack for the AI tool may be displayed. All other AI tools may be hidden. The records each include a name 442 of the object that corresponds to the record, a health status 444 that indicates a known health of the object, a hypervisor cluster indicator 446 that indicates to which hypervisor cluster the object belongs, a last updated date indicator 448 that indicates a last update date if the object has previously been updated, and an update status 450 indicating whether or not an update is available for the object. Interaction with the update status 450 via a click, a mouseover, or the like causes a details window 452 to be displayed indicating current versions of objects in the AI stack 400, such as a current AI tools version, a current operating system version, a current hypervisor version, a current storage version, and/or a current firmware version that are all part of and/or used by the current version of the object. The window 452 may include a view details button 454 that enables viewing more detailed information about the object. Upon selection of the view details button 454 and/or upon clicking the window 452, a software details screen, such as screen 470 of FIG. 13 may be displayed showing a current version 472 and one or more update versions 474 and 476. The current version 472 may be marked with a tag making clear that the version is the current version. In some embodiments, one of the update versions 474 and 476 may include a tag making clear that the corresponding update version is the latest version (e.g., version 6.9.9).

Upon selection of a record in the screen 440 of FIG. 12, a precheck button 456 may be used to precheck a compatibility of an update of the AI stack 400 for the rack(s) with a proposed update. The precheck button 456 may be used to check compatibility and download of the update to then apply the update at a later time. However, if the update is to be deployed during or after the download of the update without waiting for later update initiation, the update may be applied using an update button 458 that causes the update and pre-check to be confirmed sequentially in response to the selection of the update button 458. Additionally or alternatively, the precheck button 456 may be used to download the update, and the update button 458 may be disabled until after the update has been downloaded.

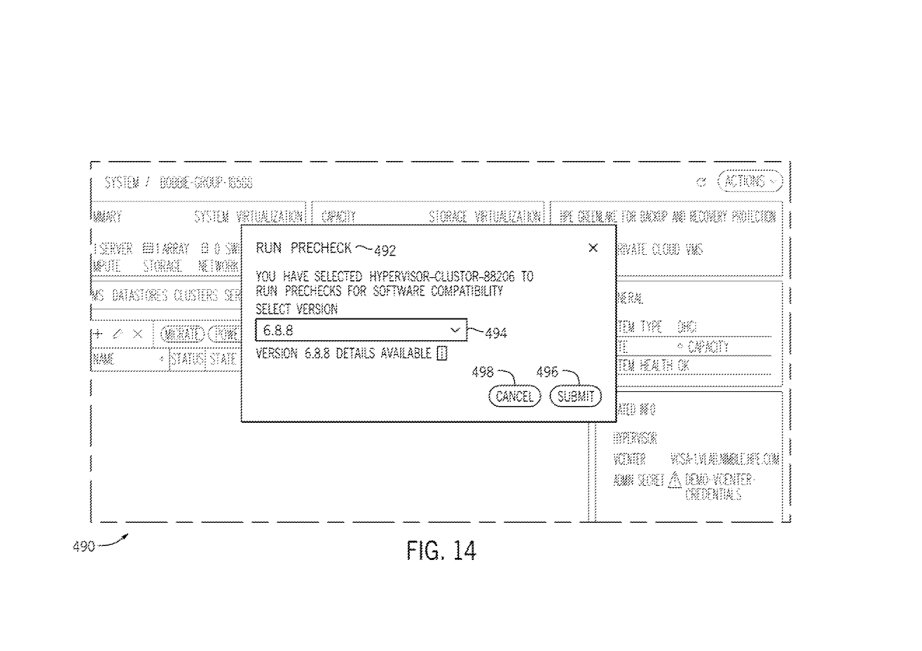

Upon selection of the precheck button 456 of FIG. 12, the private cloud AI API/UI 124 may cause a precheck screen, such as screen 490 of FIG. 14, to be presented. The screen 490 includes a title 492 making clear that a selected hypervisor cluster is selected to run a precheck. A menu 494 may enable selection of which version is to be prechecked for an update. To begin the precheck, a submit button 496 is presented that, upon selection, causes the private cloud AI API/UI 124 to cause the selected update to be prechecked and/or downloaded. If the precheck is not to begin, a cancel button 498 may be selected to return to a previous screen without initiating the precheck of the selected update.

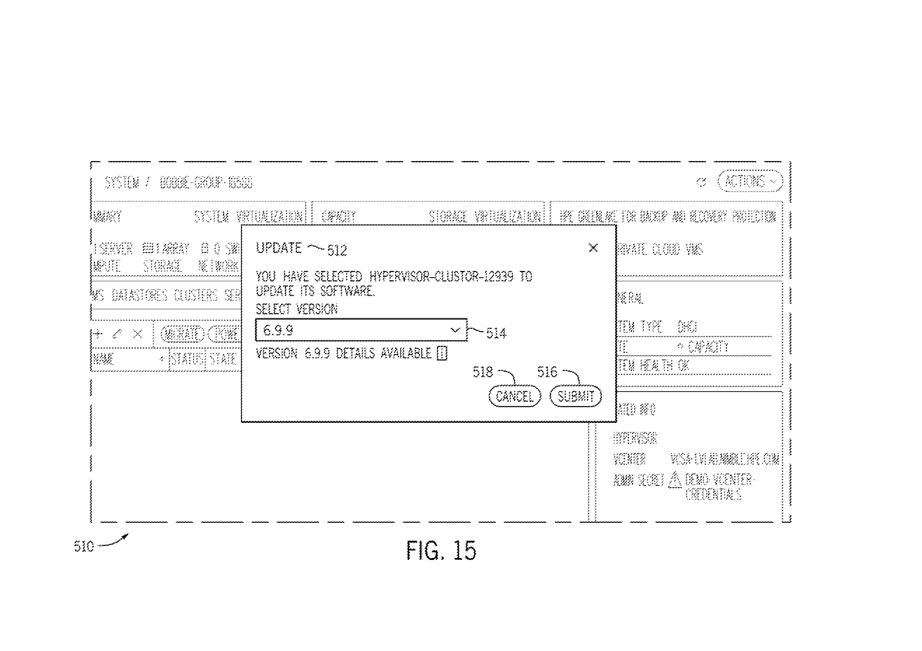

Upon selection of the update button 458 of FIG. 12, the private cloud AI API/UI 124 may cause an update screen, such as screen 510 of FIG. 15, to be presented. The screen 510 includes a title 512 making clear that a selected hypervisor cluster is selected to be updated. A menu 514 may enable selection of which version is to be updated. To begin the update, a submit button 516 is presented that, upon selection, causes the private cloud AI API/UI 124 to cause the selected update to be downloaded and/or deployed. If the update is not to begin, a cancel button 518 may be selected to return to a previous screen without deploying the selected update.

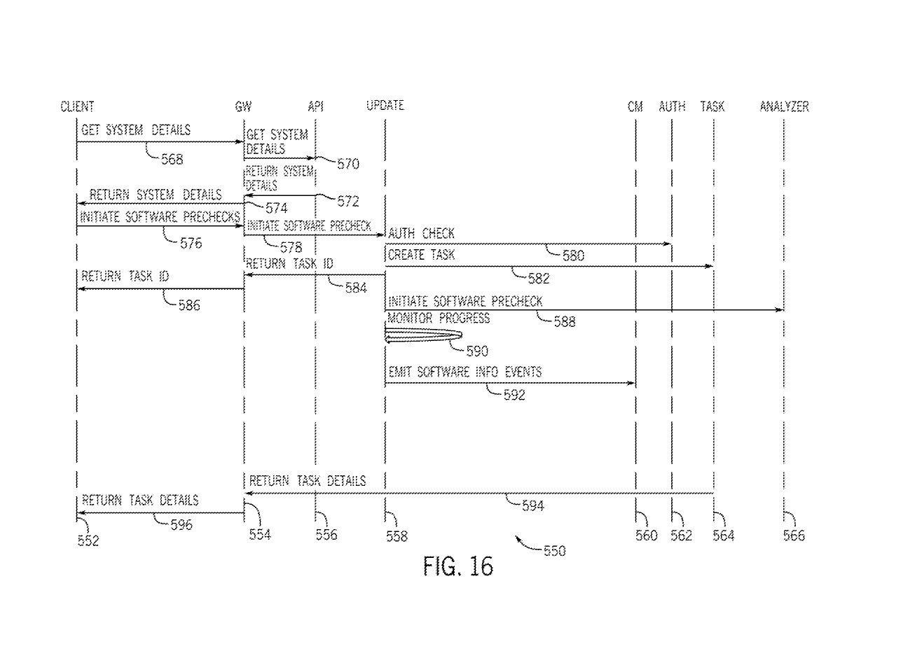

FIG. 16 is a flow diagram of a software precheck process 550 that shows exchanges of operations and/or data between components of the remote cloud management system 112 and/or the private cloud system 102 as part of a software precheck that may be initiated using the submit button 496 of FIG. 14. A client 552 may be an application implemented in and/or presented via the private cloud AI API/UI 124 that may be accessed by the customer/user/organization. A gateway (GW) 554 may be part of a container orchestration system that is used to load balance workloads. For instance, if the container orchestration system includes Kubernetes, the GW 554 may be an Istio gateway that defines the load balancer. An API aggregator (API) 556 may be part of the remote cloud management system 112 (e.g., the private cloud AI API/UI 124) that is used to display resources using API inventory. An updater mechanism (update) 558 may be implemented using orchestration in the remote cloud management system 112 to perform updates and/or obtain information from the private cloud system 102. A communication mechanism (CM) 560 may be a communication mechanism used for the container orchestration system. For instance, when the container orchestration system includes Kubernetes, the CM 560 may include Kafka. An authorizer (auth) 562 may be used to perform authorizations and may be part of the remote cloud management system 112 or a related platform, such as the authorizer 140. A task manager (task) 564 may be part of the remote cloud management system 112 and/or private cloud system 102 infrastructure that provides a tracking framework for ongoing and/or scheduled tasks. An analyzer 566 may be part of the remote cloud management system 112 and/or private cloud system 102 infrastructure that collects information from the on-prem infrastructure services to check on health of the components of the on-prem infrastructure.

The client 552 starts the software precheck process by requesting system details (568) for the private cloud system 102 from the GW 554. The GW 554 then forwards the request (570) to the API 556. The API 556 returns the system details (572) to the GW 554 that then forwards the system details (574) to the client 552. These details may ensure that the system details in the client are up to date. The client 552 then sends a request (576) to the GW 554 to initiate a precheck to verify a non-degraded state of the private cloud system 102 with no failed components and/or verify that an update is compatible. The GW 554 then forwards the request (578) to the update 558. The update 558 requests authorization (580) from the auth 562 using credentials entered into the client and/or stored during setup. If the authorization is successful, the update 558 creates a task (582) in the task 564 and returns a task identifier (task id) (584) to the GW 554 that forwards the task id (586) to the client 552 to enable tracking of the software precheck task. Using this task id, the client 552 and/or any other component may poll and request status of the software precheck. For instance, the client 552 may present a graphical interface that shows a percentage complete of the software precheck that may be updated by polling the update 558, CM 560, the task 564, and/or any other suitable components.

Upon successful authorization and task creation, the update 558 initiates the software precheck (588) with the analyzer 566 to cause it to collect information from on-prem infrastructure services for the private cloud system 102. For instance, the information may indicate whether any components are in a degraded state and/or suitable for/compatible with a planned update. The update 558 may monitor progress (590) of the software precheck and transmit any software info events (592) to the CM 560. When the task is completed and the software precheck is completed, the task 564 may notify the GW 554 by returning task details (594) to the GW 554 that forwards the task details (596) to the client 552.

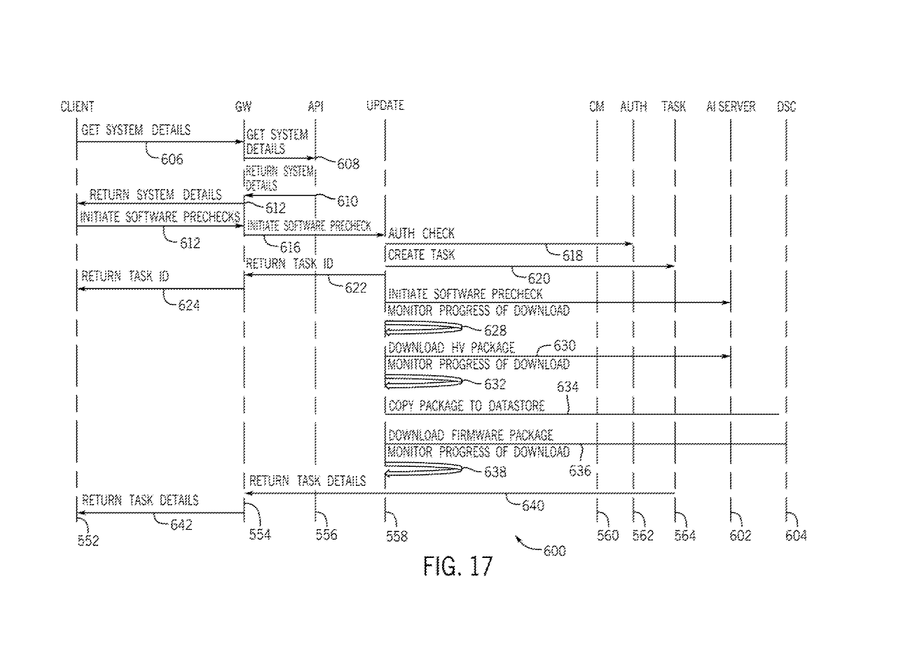

As previously noted, in some embodiments, the software prechecks may be included with a download of an update package and/or may be separate from the download of the update package. FIG. 17 is a download process 600 that shows exchanges of operations and/or data between components of the remote cloud management system 112 and/or the private cloud system 102 as part of a software precheck that may be initiated using the submit button 516 of FIG. 15. Some of the components, such as the client 552, the GW 554, the API 556, the update 558, the CM 560, the auth 562, and the task 564 may be common between the process 600 and the process 550 of FIG. 16. The process 600 also utilizes an AI service 602 and a data services connector (DSC) 604. The AI service 602 may include the AI software 107 of the private cloud system 102 and/or the platform on which the AI software is implemented. The DSC 604 may be the DSC 108 of FIG. 1 in the private cloud system 102 used to interface with the remote cloud management system 112.

The client 552 starts the software precheck process by requesting system details (606) for the private cloud system 102 from the GW 554. The GW 554 then forwards the request (608) to the API 556. The API 556 returns the system details (610) to the GW 554 that then forwards the system details (612) to the client. As previously noted, these details may ensure that the system details in the client are up to date. The client 552 then sends a request (614) to the GW 554 to initiate a precheck to verify a non-degraded state of the private cloud system 102 with no failed components and/or verify that an update is compatible. The GW 554 then forwards the request (616) to the update 558. The update 558 requests (618) authorization from the auth 562 using credentials entered into the client and/or stored during setup. If the authorization is successful, the update 558 creates a task (620) in the task 564 and returns a task identifier (task id) (622) to the GW 554 that forwards the task id (624) to the client 552 to enable tracking of the download and/or software precheck task. Using this task id, the client 552 and/or any other component may poll and request status of the download and/or software precheck. For instance, the client 552 may present a graphical interface that shows a percentage complete of the download and/or software precheck that may be updated by polling the update 558, CM 560, the task 564, and/or any other suitable components.

The update 558 also initiates download of updates to AI tools from the software catalog using an orchestrator (626) for the AI service 602, such as the private cloud AI platform orchestrator 122 of the remote cloud management system 112 of FIG. 1. The update 558 then monitors progress of the download (628). During and/or after download for the AI service 602, the update 558 may download a hypervisor (HV) package (630) using the DSC 604 and monitor the download (632). After download of the HV package, the update 558 copies the HV package (634) to a datastore for the HV. During and/or after downloading/copying the HV package, the update 558 downloads a firmware package (636) using the DSC 604 and monitors progress of the download (638). When the task is completed and the software prechecks/downloads are completed, the task 564 may notify the GW 554 by returning task details (640) to the GW 554 that forwards the task details (642) to the client 552. In some embodiments, if any operation fails (e.g., such as a download), such failures may be indicated in the returned task details.

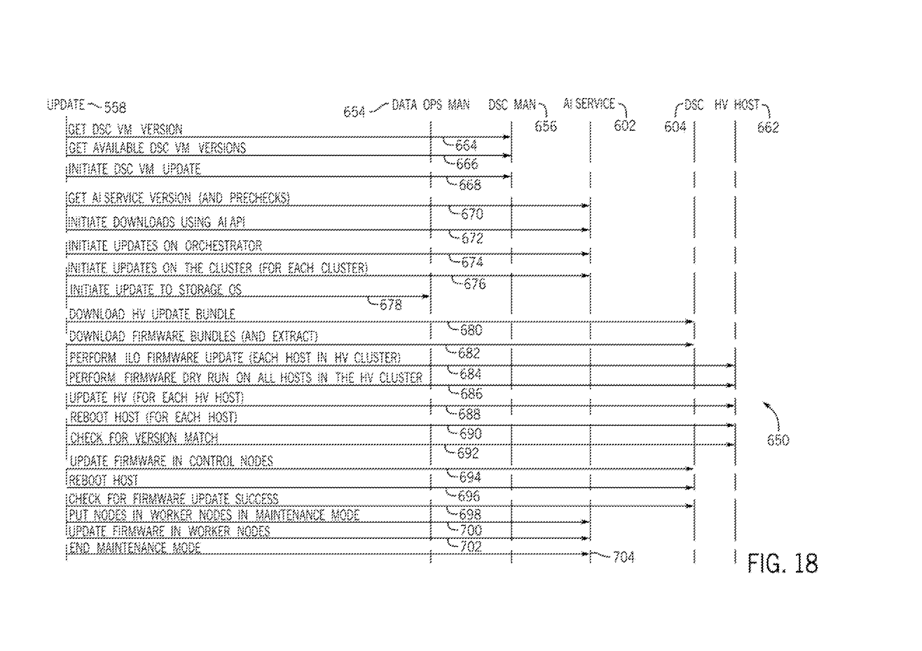

Once the software is downloaded and/or software prechecks have been successfully completed, updates may be applied to the private cloud system 102. FIG. 18 shows an example update process 650 that may be used by the remote cloud management system 112 and/or the private cloud system 102 to apply updates to the private cloud system 102. The process 650 uses the update 558, the AI service 602, and the DSC 604. The process 650 also uses a data operations manager (data ops man) 654 to interface with storage 103, such as interfacing with its operating system. The process 650 also uses a DSC VM manager (DSC man) 656 to manage a VM of the DSC 604. Furthermore, the process 650 involves HV hosts 662.

Since the DSC 604 is software on-prem that connects the rack(s) to the remote cloud management system 112, a DSC VM used to implement the DSC may be the first targeted update. Accordingly, the update 558 gets the DSC VM version (664) from the DSC man 656 and obtains a list of available DSC VM versions (666) from the DSC man 656. The update 558 then initiates an update to the DSC VM (668) for the DSC man 656 using one of the available DSC versions, such as the most current full-release version. Each of the updates discussed in the process 650 may include task creation, tracking, and/or communication using the CM 560 like software precheck and download tasks previously discussed in relation to FIGS. 16 and 17.

After completing the DSC VM update, the update 558 begins updating the AI tools by getting an AI service version (670) from the AI service 602. The update 558 may also perform software prechecks for the AI tools to be downloaded using the orchestrator (e.g., private cloud AI platform orchestrator 122) and workload clusters of worker nodes 104. With successful prechecks, the update initiates downloads of AI tools updates (672) using the AI service 602. The update 558 then initiates the downloaded updates on the orchestrator (674) and applies the downloaded updates to each of the workload clusters (676).

After completing AI tools updates, the update 558 initiates an update to the OS of the storage 103 (678) to the data ops man 654 to update the OS. After completing the storage OS update, the update 558 downloads an HV update bundle (680) using the DSC 604. Before, after, or during downloading the HV update bundles, the update 558 may download server firmware bundles and extract the firmware (682). The update 558 then performs an iLO firmware update (684) for each HV host 662 in the HV cluster. The update 558 may also perform a dry run of firmware updates (686) on all HV hosts 662 in the HV cluster. The update 558 then updates each HV (688) for each HV host 662. Updating each HV may include first placing each HV host 662 in a maintenance mode before applying the update. After updating each HV host 662, the update 558 causes each HV host to be rebooted (690) and checks for a version match (692) to the targeted version of the firmware after the reboot to confirm that the firmware update has been completed successfully.

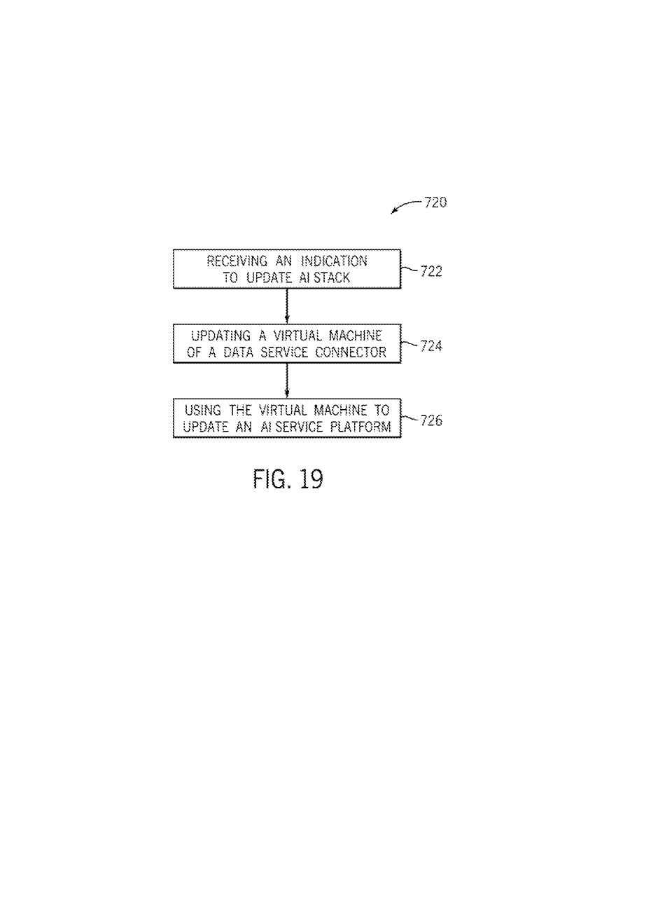

In some embodiments, at least some of the previously discussed processes may include more or fewer operations. For instance, the process 650 may include fewer or more steps in the software update without straying from the teachings herein. For example, FIG. 19 represents a process 720 that includes receiving, via a user interface (e.g., the private cloud AI API/UI 124) of the remote cloud management system 112 an indication to update a stack (e.g., the AI stack 400) of artificial intelligence (AI) tools in the private cloud system 102 (block 722). In response to receiving the indication, the remote cloud management system 112 updates a virtual machine of the DSC 604 of the private cloud system 102 using the remote cloud management system 112 (block 724). In response to receiving the indication and updating the virtual machine, the remote cloud management system 112 uses the updated virtual machine to update an AI service platform used to deploy the AI tools (block 726). Updating the AI service platform, may include obtaining a current version for the AI service platform, pre-checking for compatibility of an update to the AI service platform and health of components of the AI service platform, downloading the update using an AI application programming interface (API) of the remote cloud management system 112, and installing the update. Such updates may include updating any portion of the AI stack, such as storage OS, HV, control node firmware, and/or worker nodes firmware using any of the techniques discussed in relation to the process 650.

The update 558 then updates firmware control nodes 106 (694), such as the AI software control plane 110, and causes the HV hosts 662 to be rebooted (696). The update 558 may verify success (698) by checking an iLO installation queue to confirm whether the firmware update has completed after the reboot.

The update 558 then updates the worker nodes 104 by first putting the worker nodes in a maintenance mode (700), updating the firmware in the worker nodes 104 (702), and removing the worker nodes from the maintenance mode (704).

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A system, comprising:
a remote cloud management system comprising a private cloud AI platform orchestrator that is remote from a private cloud system being configured to:
interface with the private cloud system;
orchestrate artificial intelligence (“AI”) operations on the private cloud system using the private cloud AI platform orchestrator; and
manage AI software installed in the private cloud system.

2. The system of claim 1, wherein the remote cloud management system comprises an AI application programming interface (API) management system configured to manage the AI software in the private cloud system.

3. The system of claim 2, wherein the AI API management system utilizes a plurality of APIs to interface with the AI software in the private cloud system.

4. The system of claim 2, wherein managing the AI software comprises updating the AI software in the private cloud system remotely using the remote cloud management system.

5. The system of claim 4, wherein the remote cloud management system is configured to interface with the private cloud system using a tunnel implemented using a data services connector of the private cloud system.

6. The system of claim 5, wherein the remote cloud management system is configured to update the data services connector before updating the AI software.

7. The system of claim 4, wherein the remote cloud management system is configured to receive a connection from a rack in the private cloud system and complete an initial configuration of the rack.

8. The system of claim 7, wherein the initial configuration comprises updating the AI software.

9. The system of claim 8, wherein updating the AI software comprises sequentially updating multiple components of the private cloud system in a hierarchical order based a selection of an update option.

10. The system of claim 9, wherein the selection of the update option comprises a single click update selection.

11. A computer-implemented method, comprising:
receiving, via a user interface of a remote cloud management system, an indication to update a stack of artificial intelligence (AI) tools in a private cloud system, wherein the remote cloud management system is configured to remotely manage the private cloud system;
in response to receiving the indication, updating, via the remote cloud management system, a virtual machine of a data services connector (DSC) of the private cloud system using the remote cloud management system;
in response to receiving the indication and updating the virtual machine, using the virtual machine to update an AI service platform used to deploy the AI tools, wherein updating the AI service platform comprises:
obtaining a current version for the AI service platform;
pre-checking for compatibility of an update to the AI service platform and health of components of the AI service platform;
downloading the update using an AI application programming interface (API) of the remote cloud management system; and
installing the update.

12. The computer-implemented method of claim 11, wherein the indication comprises a single input to update an entirety of the stack including the AI service platform and the virtual machine.

13. The computer-implemented method of claim 11, wherein the private cloud system comprises an on-premises cloud that is implemented at least partially on site of a customer, and the remote cloud management system is implemented at one or more sites maintained by a provider of the remote cloud management system.

14. The computer-implemented method of claim 11, comprising, in response to updating the AI service platform, updating an operating system of storage of the private cloud system.

15. The computer-implemented method of claim 14, comprising, in response to updating the operating system of the storage of the private cloud system, updating hypervisors of the private cloud system using the remote cloud management system.

16. The computer-implemented method of claim 15, comprising, in response to updating the hypervisors, updating firmware of control nodes and worker nodes in the private cloud system.

17. The computer-implemented method of claim 11, wherein updating the virtual machine of the DSC comprises:
determining a version of the virtual machine of the DSC;
determining one or more available versions for the virtual machine of the DSC; and
updating the virtual machine of the DSC to one of the one or more available versions of the virtual machine of the DSC.

18. The computer-implemented method of claim 17, wherein the one of the one or more available versions comprises a most recent stable version of the virtual machine.

19. The computer-implemented method of claim 11, wherein installing the update comprises:
installing updates to a private cloud AI platform orchestrator of the remote cloud management system; and
installing updates to worker nodes of the private cloud system used to implement the AI tools.

20. A tangible, non-transitory, and computer-readable medium having stored thereon instructions, that when executed by one or more processors of one or more computers, are configured to cause the one or more computers to:
present a user interface via a remote cloud management system that is configured to remotely manage an on-premises cloud system using a tunnel implemented using a data service connector (DSC) of the on-premises cloud system, wherein the on-premises cloud system comprises a plurality of artificial intelligence (AI) tools;
receive an indication to update to AI tools;
in response to the indication, update a virtual machine used to implement the DSC;
after completing the update to the virtual machine, update an AI service platform used to implement the AI tools using the DSC implemented using the updated virtual machine;
after completing the update to the AI service platform, update a hypervisor on one or more hypervisor hosts of the on-premises cloud system; and
after completing the update to the hypervisor, update firmware control nodes and worker nodes of the on-premises cloud system.
